(19) United States
(12) Patent Application Publication
(10) Pub. No.: US 2016/0248311 A1
(43) Pub. Date: Aug. 25, 2016

(54) Rotational Inertia Electricity Generator

(71) Applicant: Ian Isbell, Grass Valley, CA (US)

(72) Inventor: Ian Isbell, Grass Valley, CA (US)

(21) Appl. No.: 14/630,891

(22) Filed: Feb. 25, 2015

(51) Int. Cl. H02K 35/00; F21L 13/06; F21L 4/08; H02K 7/07; H02K 16/00

(52) U.S. Cl. CPC H02K 35/00; H02K 7/07; H02K 16/00; F21L 4/08; F21L 13/06

(57) ABSTRACT

An apparatus has a housing having a long axis, a rotor mounted within the housing rotatable on one or more bearings on the same axis as the housing, a stator concentric with the rotor, the stator constrained to be stationary relative to the housing, and an arrangement of magnets and electrical windings configured to generate electrical current by relative rotation between the rotor and the stator. A user, grasping the housing, rotates the housing first in one rotational direction around the axis, and then in the opposite rotational direction around the axis, causing relative rotation between the stator and the rotor in repeating opposite directions, creating electrical current from the motion imparted.

### BACKGROUND OF THE INVENTION

1. Field of the Invention

The present invention is in the field of electronics and pertains particularly to methods and apparatus for generating electricity using manually produced inertia.

2. Discussion of the State of the Art

In the field of electronics, it is very well known that electricity may be generated using an electromagnetic rotor/stator assembly. Rotation of the rotor or stator in the electrically wound rotor/stator assembly causes generation of electricity. The inventor is aware of such generators incorporated in devices such as flashlights. In one apparatus known to the inventor, a flashlight has a rotor/stator assembly that is manually driven to generate electricity by using a connected crank handle accessible from outside the housing of the assembly. In another apparatus known to the inventor, a flashlight has an elongate chamber hosting a freely-sliding magnet that may repeatedly slide past a centrally located induction wire when a user shakes the flashlight. The generated power can be stored in a capacitor or used to power a light source.

In the first apparatus, a problem exists in that the crank extends through the flashlight housing and therefore represents a point where the integrity of the housing may be compromised leading possibly to degradation of components inside the unit. In the second apparatus the magnet travels half of entire length of the internal tubular chamber before making contact with the induction wire resulting in more work input to produce sufficient power for use.

Therefore, what is clearly needed is an electricity generator that operates with less manual input.

### BRIEF SUMMARY OF THE INVENTION

In an embodiment of the invention an apparatus is provided comprising a housing having a long axis, a rotor mounted within the housing rotatable on one or more bearings on the same axis as the housing, a stator concentric with the rotor, the stator constrained to be stationary relative to the housing, and an arrangement of magnets and electrical windings configured to generate electrical current by relative rotation between the rotor and the stator. A user, grasping the housing, rotates the housing first in one rotational direction around the axis, and then in the opposite rotational direction around the axis, causing relative rotation between the stator and the rotor in repeating opposite directions, creating electrical current from the motion imparted.

In one embodiment the housing is adapted to be held between a users left and right hands, and the user imparts the repeated opposite rotational relative motion between the stator and the rotor by moving the opposite hands in opposite directions repeatedly. Also in one embodiment the apparatus further comprises an electrical storage apparatus connected to the electricity generator with suitable circuitry such that electricity generated by relative rotation in either direction is stored in the electrical storage apparatus. In one embodiment the apparatus further comprises lighting components, wherein the apparatus provides a flashlight rechargeable by opposite rotation of the flashlight housing. Also in one embodiment the apparatus further comprises a freewheel mechanism connected to the rotor, constraining the rotor to rotate in one direction only relative to the stator.

In one embodiment the apparatus comprises a plurality of rotors concentric with a plurality of stators with the stators all constrained to be stationary with the housing. In one embodiment all of the rotors rotate independently. In another embodiment individual ones of the rotors are constrained to rotate together. In one embodiment the apparatus comprises a floating ring coupled to the stator by a spring element, with the floating ring coupled to the rotor by the freewheel mechanism, such that rotational input to the casing in the free direction of the rotor is imparted to the floating ring through the spring element, which directly drives the rotor through the freewheel mechanism, wherein upon the rotational input to the casing stopping, the rotor continues to rotate relative to the stator.

In one embodiment the apparatus has a mechanical connection to a wave follower, such that the wave follower causes the housing to rotate repeatedly in opposite directions, causing the apparatus to generate electrical current. And in one embodiment the apparatus further comprises a switch input controlling a mechanism between the stator and the rotor, wherein placing the switch in one position places the mechanism in a first mode enabling motion imparted to the casing to wind up a coil spring, and placing the switch in a second position places the mechanism in a second mode enabling the spring to unwind, spinning the rotor relative to the stator and generating electricity.

In another aspect of the invention a method is provided, comprising rotating a housing as a first action in one rotational direction, causing relative rotation between a rotor mounted on bearings to rotate within the housing about the long axis of the housing, and a stator concentric with the rotor but fixed to be stationary relative to the housing, the apparatus having an arrangement of magnets and electrical windings configured to generate electrical current by relative rotation between the rotor and the stator, rotating the housing as a second action in the opposite rotational direction generating further electrical current, and repeating the steps sequentially to continue to produce electrical current.

In one embodiment of the method the housing is adapted to be held between a users left and right hands, and the user imparts the repeated opposite rotational relative motion between the stator and the rotor by moving the opposite hands in opposite directions repeatedly. In one embodiment there is an electrical storage apparatus connected to the electricity generator with suitable circuitry such that electricity generated by relative rotation in either direction is stored in the electrical storage apparatus. Also in one embodiment the apparatus provides a flashlight rechargeable by opposite rotation of the flashlight housing. Also in one embodiment there is a freewheel mechanism connected to the rotor, constraining the rotor to rotate in one direction only relative to the stator. Also in one embodiment there are a plurality of rotors concentric with a plurality of stators with the stators all constrained to be stationary with the housing. In one embodiment all of the rotors rotate independently. In another embodiment individual ones of the rotors are constrained to rotate together.

In one embodiment there is a floating ring coupled to the stator by a spring element, with the floating ring coupled to the rotor by the freewheel mechanism, such that rotational input to the casing in the free direction of the rotor is imparted to the floating ring through the spring element, which directly drives the rotor through the freewheel mechanism, wherein upon the rotational input to the casing stopping, the rotor continues to rotate relative to the stator. Also in one embodiment there is a mechanical connection to a wave follower, such that the wave follower causes the housing to rotate repeatedly in opposite directions, causing the apparatus to generate electrical current. And in one embodiment there is a switch input controlling a mechanism between the stator and the rotor, wherein placing the switch in one position places the mechanism in a first mode enabling motion imparted to the casing to wind up a coil spring, and placing the switch in a second position places the mechanism in a second mode enabling the spring to unwind, spinning the rotor relative to the stator and generating electricity.

### BRIEF DESCRIPTION OF THE SEVERAL VIEWS OF THE DRAWINGS

FIG. 1 is an elevation view of a lighting device according to an embodiment of the present invention.

FIG. 2 is an overhead view of the rotor/stator assembly of FIG. 1.

FIG. 3 is a section view of the rotor/stator assembly of FIG. 2 taken along the section lines AA.

FIG. 4 is a perspective view of the stator rotor assembly of FIG. 1.

FIG. 5 is a perspective view of a rotor/stator assembly according to another embodiment of the present invention.

FIG. 6 is an overhead view of a user operating the rotor/stator assembly of FIG. 5.

FIG. 7a is an elevation view of a rotor/stator assembly inside a housing according to another embodiment of the present invention.

FIG. 7b is a plan view illustrating operation of a freewheel mechanism of FIG. 7a.

FIG. 8a is an elevation view of an apparatus according to another embodiment of the invention.

FIG. 8b is a plan view of a mechanism of the apparatus of FIG. 8a.

FIG. 9 is an elevation view of another apparatus according to an embodiment of the invention.

### DETAILED DESCRIPTION OF THE INVENTION

In various embodiments described in enabling detail herein, the inventor provides a unique apparatus ad method for generating electricity. The present invention is described using the following examples, which may describe more than one relevant embodiment falling within the scope of the invention.

The inventor in one implementation provides a device with an induction electric motor included therein for generating electricity for use such as in lighting or charging-rechargeable devices. The present invention is described in enabling detail using the following examples, which may describe more than one relevant embodiment falling within the scope of the present invention.

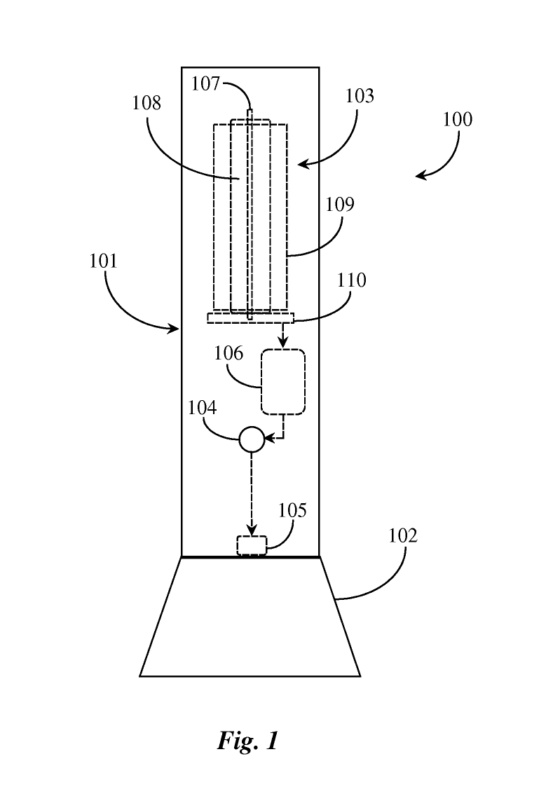

FIG. 1 is an elevation view of a lighting device 100 according to an embodiment of the present invention. Lighting device 100 may in one example be in the form of a hand-held flashlight. Flashlight 100 in this example has a casing or frame 101 that encloses the components of the flashlight. Casing 101 may be manufactured of metal, durable polymer or other resilient and durable materials. Flashlight 100 includes a light focusing apparatus 102 mounted to frame 101 and includes a lens (not illustrated) through which light from a light source may pass. Apparatus 102 may be manufactured from materials similar to those used to fabricate casing 101 and may be rotatable in one embodiment and connected to the lens for focusing light in a broad or more-narrow beam. Flashlight 100 may be scaled to a range of hand-operated sizes from very small such as a small pen light to rather large such as a long “Mag” light. A focusing apparatus is not required in order to practice the invention.

Flashlight 100 includes a rotor/stator assembly 103. Rotor/stator assembly 103 includes an axle 107, a rotor 108 mounted over the axle and a stator 109 housing the rotor. Stator 109 is adapted to be stabilized or fixed in place by frame 101 (method of attachment not illustrated). In this embodiment the stator (109) is fixed to casing while the rotor (108) is rotatable within the stator. In another embodiment the roles may be reversed, with element 108 as the stator fixed to the casing via load-bearing assembly and element 109 as the rotor. Rotor 108 may be electromagnetically wound for interaction with magnets installed on the stator to generate electricity to accomplish electricity generation as is known in the art. Rotor 108 also may make contact with stator magnets via armature brushes (not illustrated).

Rotor 108 in one embodiment is freely rotatable in both rotational directions. In another embodiment the rotor may be constrained to rotate in one direction only, which may be either rotational direction. To constrain rotation of the rotor in one direction a freewheel mechanism 110 may connected to the rotor. Freewheel mechanisms are well-known in the art, and may be implemented in several different ways, which will be apparent to the skilled person, so no detail of the mechanism is provided here.

Flashlight 100 in this example also includes circuitry not illustrated connecting electrical generation elements in the generator to an electrical storage device 106. Storage device 106 may be any one of several sorts of capacitor banks or rechargeable batteries, or any other sort of electrical storage mechanisms known in the art. Both the necessary circuitry and battery systems are known to the skilled person, so not detailed in this specification.

There may be an on/off switch 104 switching power from storage 106 to a lighting element 105. Lighting element 105 may be a bulb or an LED-type light source without departing from the spirit and scope of the present invention. Typical electric components like armature brushes, electrical wiring and connections are not illustrated in detail as there may be many different variations of wiring and electric components within flashlight 100 without departing from the spirit and scope of the present invention.

In various embodiments of the invention manual rotation of the body (casing or frame) of the flashlight around the long axis of the flashlight functions to cause desired rotation of the rotatable member or members (rotor/stator) of rotor/stator assembly 103. An imparted quick rotation of the casing, attached to the stator, results in relative rotation of the rotor and the stator, generating electricity in the same manner as imparted rotation of a rotor in any other electrical generator known in the art. However, in embodiments of the present invention in which the rotor may rotate freely in either direction, a user may apply rotation of the casing in one rotational direction, followed immediately by rotation in the opposite rotational direction, and these opposite applications of movement may be repeated, with each rotational movement resulting in generation of electricity by the rotor/stator assembly, due to rotational inertia of the rotor.

Copper windings in the rotatable member of the rotor/stator assembly may be interchangeable in some embodiments for designs with differing magnet locations. In one embodiment, copper-wound rotatable components may be of varying designs such as a spiral design without departing from the spirit and scope of the present invention. In one embodiment, the rotatable member of the rotor/stator assembly may be limited by a coil or leaf spring assembly fixed to casing or frame 101, wherein a tab on the rotating member makes contact with a specific part or parts of the spring assembly. Rotation may also be constrained or directed by gearing the rotation using one or more than one gear or gear assembly. A gear selection switch or lever may be provided with external access to enable a user to switch gears relative to rotation.

In an embodiment incorporating freewheel mechanism 100 shown in FIG. 1, a rotational motion imparted to the casing in the direction that the rotor is free to rotate will impart rotational momentum to the rotor in that direction, which will continue to rotate in the same direction when the imparted motion is stopped or reversed, and as long as the rotor continues to rotate and the casing is restrained, the device will generate by virtue of relative rotation between the rotor and the stator. By applying repeated rotation alternated in opposite directions to the casing a user may continue to add rotational momentum to the rotor in its free direction.

In this example, rotor/stator assembly 103 is integrated in a flashlight. However, this implementation is not required in order to practice the present invention. Assembly 103 may be integrated with any device or apparatus that uses electricity and that can be manually rotated by hand in quick opposing movements. The inventor illustrates a flashlight in this embodiment as one example of implementation.

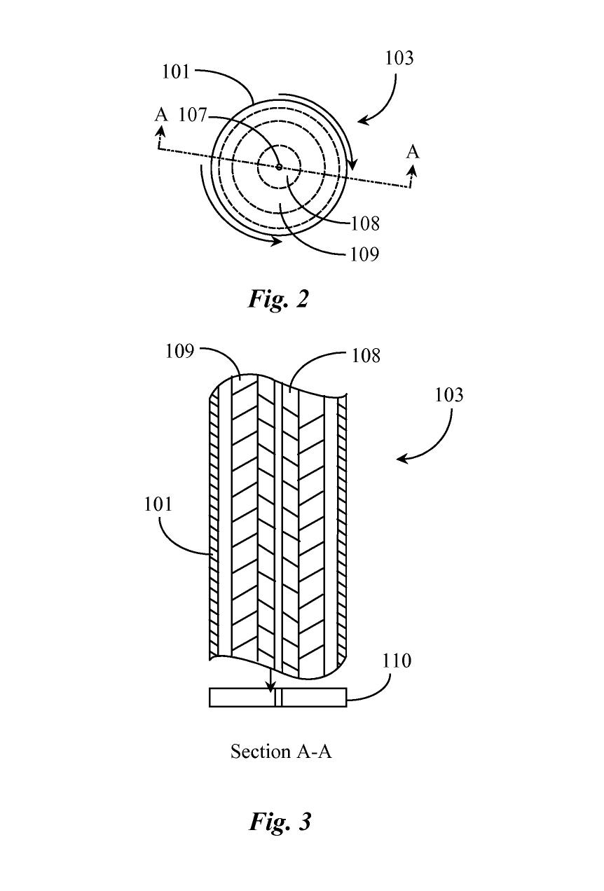

FIG. 2 is a plan view of rotor/stator assembly 103 of FIG. 1. FIG. 3 is an elevation sectioned view of the rotor/stator assembly of FIG. 2 taken along the section line AA. Referring now to FIG. 2, rotor/stator assembly 103 includes axle 107 over which rotor 108 is rotationally mounted. Stator 109 in this example is fixedly attached to frame 101 of the flashlight. In this example the rotor rotates about the axle freely in either direction. Relative rotation between the stator and the rotor occurs as a result of manual manipulation of flashlight frame 101 in short, opposite rotational movements of the flashlight frame about its long axis.

Referring now to FIG. 3, rotor/stator assembly 103 is depicted in section view A-A. A freewheel mechanism 110 may or may not be connected to rotor 108. In some embodiments rotor 108 may be off-center from stator 109 and the centerline of the casing. An off-center rotor design may operate without manual input if the device is placed in a state of general motion such as being placed in a backpack or in a pocket while walking, hiking, or jogging, which may cause rotor 108 to rotate relative to the stator and thus provide for electrical generation. In an alternative embodiment an off-center weight may be fixed to the rotor shaft to accomplish the same effect.

In one embodiment, freewheel 110 may have a spring assembly (not illustrated) for a purpose of constraining the rotation of the rotor in the assembly, and may return rotational momentum back in the free-spinning rotation. This may be accomplished through an interfacing tab or protrusion on the rotating component that interfaces with the spring assembly. The spring assembly may contain a coiled spring or a metallic leaf-spring. In one embodiment a freewheel, a spring assembly, and a gear assembly containing one or more than one gear may be combined to constrain and or direct the rotation of the rotor in the assembly without departing from the spirit and scope of the present invention.

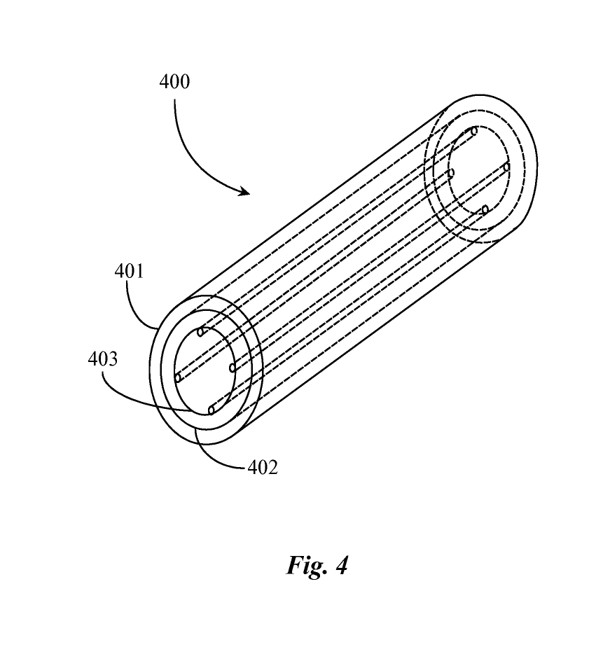

FIG. 4 is a perspective view of a very simple rotor/stator configuration 400. In configuration 400 a rotor 403 is depicted within a stator 402 enclosed by a housing 401. Rotor 403 may exhibit electrical windings and may be rotational about an axle. Stator 402 may be fixed to frame or housing 401. In one embodiment, copper windings may be spiral in shape to simulate higher revolutions per minute (RPM). In one embodiment rotor 403 may be mounted off center on its host axle (axle not illustrated). In a variation of this embodiment, the rotor may be attached to a freewheel mechanism.

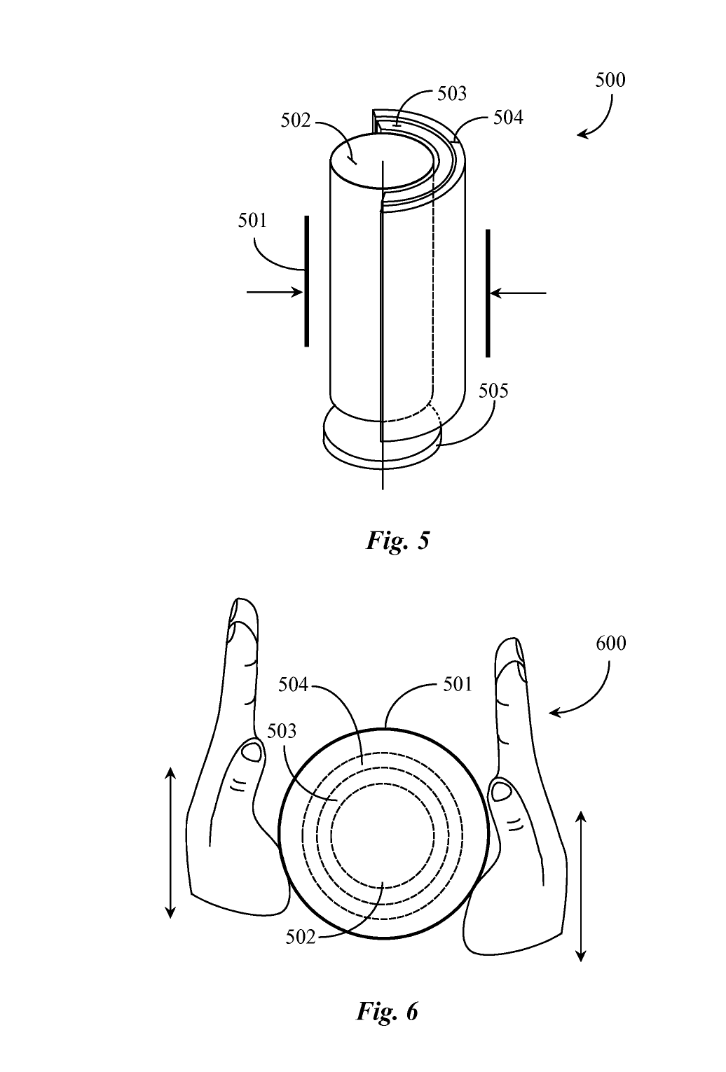

FIG. 5 is a perspective view of a rotor/stator assembly 500 according to another embodiment of the present invention. FIG. 6 is an overhead view of a user operating the rotor/stator assembly 500 of FIG. 5. Referring now to FIG. 5, a frame or casing such as a flashlight casing is depicted by lines 501 representing opposite sides of such a casing. A stator 502 is depicted herein and in this example is fixed to casing or frame 501. A rotor 503 is depicted in a concentric relationship with stator 502. Rotor 503 may rotate about stator 502 in either rotational direction mounted to one or more bearing assemblies (not illustrated). Rotor 503 may operate with or without previously mentioned constraint mechanisms such as a gear assembly (not illustrated) or a freewheel mechanism that allows for rotation in only one direction. In some embodiments elements may be arranged with spring elements such that a spring is compressed by a user's mechanical input, and the spring drives to rotor. In another embodiment elements are arranges such that a user's input motion is used to wind a spring, which may later be released to spin the rotor and generate electricity. These embodiments are described more fully below.

Assembly 500 in this example further includes a second stator 504 that assumes a concentric relationship with rotor 503 and stator 502, and that may also be fixed to frame 501. Assembly 500 includes an optional freewheel mechanism 505 connected to rotor 503 (connection not shown). In other embodiments of this concentric configuration further rotors and stators may be incorporated concentrically about the assembly shown, providing a plurality of rotors rotatable within the concentric stators. Magnets, windings and circuitry may be incorporated for causing production of electricity by the relative rotation between the rotors and stators. All stator portions in such an embodiment are fixed to one another and to the frame and do not exhibit relative rotation. Rotor portions in such an assembly may be fixed to one another in any configuration or any and all may be free to rotate independently.

Referring now to FIG. 6, a user is represented herein by left and right hands 600. In this overhead view, stator 502 is concentric with and in relative true position with casing 501. Rotor 503 and stator 504 are illustrated concentric in relationship with the stator and share a center line. In use of the present invention, a user may rotate casing 501, a flashlight casing for example, using back and forth movement of the hands against the casing as depicted by the directional arrows, the direction of the hand movement being opposite at any point in time. Such motion urged on the casing functions to cause rotation of the stator portions in this example. The movement causes relative rotation between the stator portions and the rotor portions to generate electricity, but the rotor portions do not remain stationary. They begin to rotate in the induced direction of the stator because of magnetic coupling. The freewheel mechanism, if used, imparts rotational momentum to the rotor, so the rotor will tend to continue to move in the induced direction when the user reverses the hand direction and therefore the rotational direction of the stator. This motion creates forces that may be sensed by the user, who may use the sensed forces to time the reversals of direction to maximize the operation of the apparatus.

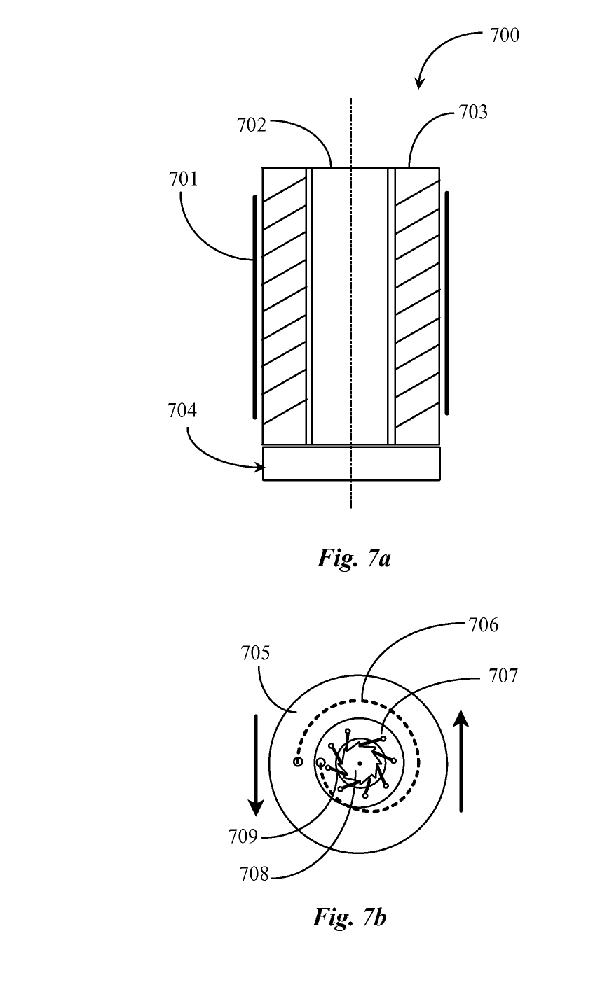

FIG. 7a is an elevation view of a rotor/stator assembly 700 in an alternative embodiment of the invention. A rotor 702 is enabled to rotate on a centerline within a stator 703, shown in cross-section. The stator is fixed to a frame represented on opposite sides by lines 701. The rotor interfaces with the stator through a spring-loaded freewheel mechanism 704.

FIG. 7b is a plan view of freewheel mechanism 704 illustrating at least principles of operation. An outer portion 705 is integral with, or at least firmly attached to stator 703, which in turn is attached to casing 701. A portion 707 within portion 705 is enabled to rotate relative to portion 705, but is constrained by a spring 706. An inner portion 708, fastened to rotor 702 has a ratchet-wheel interface toward portion 707, and portion 707 has at least one, and preferably a plurality of pawls 708 to engage ratchet wheel 708.

When a user applies rotational movement to the casing and hence to the stator and portion 705 of the freewheel mechanism as indicated by the opposite facing arrows, counterclockwise motion is accomplished to portion 705. As portion 707 is free to rotate, but constrained by spring 706, and having mass to provide rotational inertia, there will be relative rotation between portions 705 and 707 which will wind spring 706. Increasing torque on portion 707 will be experienced because of the winding of the spring, and pawls 709 engaging ratchet wheel 708 will turn the rotor that is fastened to the ratchet wheel. As the user completes the rotational input, stopping before reversing, spring 706 will unwind proving increased torque to wheel 708 and hence rotor 702, which will accelerate its spin counterclockwise. As the users input stops, and then reverses the rotor will continue to turn counterclockwise, and the pawls will ride over the ratchet wheel interface imparting very little impediment to the rotor.

In this manner the user may repeatedly provide alternating clockwise, then counterclockwise motion to the stator through the casing, and the rotor will continue to turn counterclockwise, experiencing a sequence of rotational inputs through the spring and pawls.

The skilled person will realize that the depiction of FIGS. 7a and 7b are meant to be exemplary, and that the functionality may be accomplished through a variety of mechanisms in a variety of different ways using ratchets and springs of different sorts.

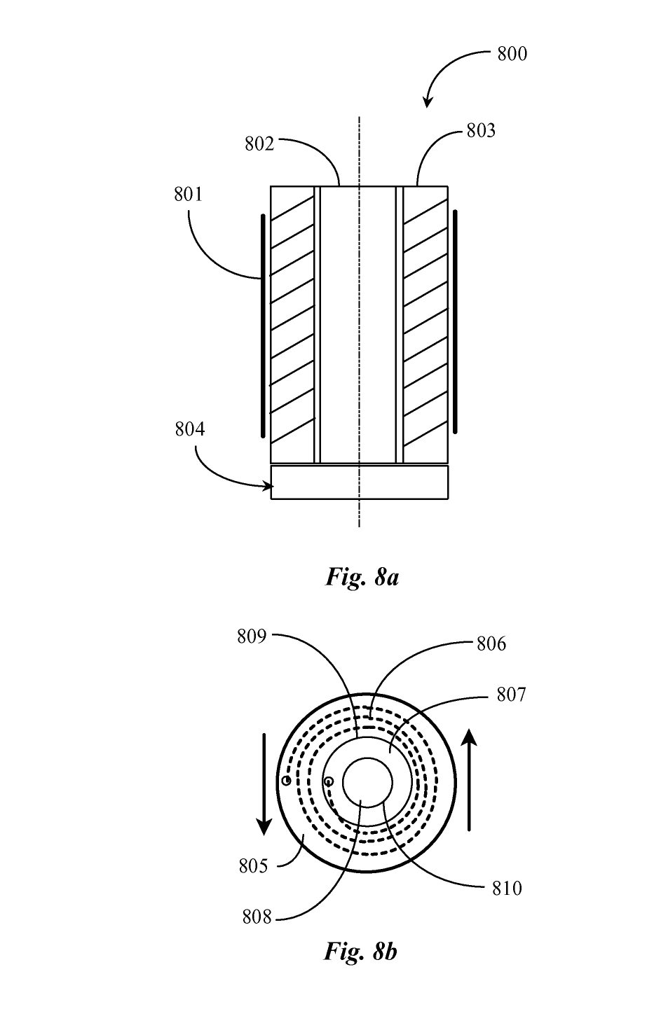

FIGS. 8a and 8b illustrate a rotor/stator assembly and mechanism in an alternative embodiment of the invention. In this embodiment there are two controllable ratchet interfaces, one at radius 809 and the other at radius 810. Spring 806 in this embodiment is a coil spring similar to spring 706 in FIG. 7b, except spring 806 has multiple turns such that complete winding of the spring may require several full revolutions between portions 805 and 807.

Details of switches and mechanisms of the two ratchet interfaces are not provided here, as the functionality, which is described in enabling detail, may be provided in a variety of different ways, all of which should be apparent to the skilled person.

Referring now to the interface at radius 809 between portion 805 and portion 807, that interface is implemented such that portion 807 is controlled by a mechanical or electrically-operated switch to operate in either of two modes. In a first mode portion 807 is constrained by a ratchet mechanism (freewheel) to rotate clockwise relative to portion 805, but not counterclockwise. In a second mode, portion 807 is free to rotate in either direction relative to portion 805.

Referring now to the interface at radius 810, between portion 807 and portion 808, this interface is controlled by the same switch to operate in the first mode to be fixed rotationally to portion 807. Portion 808 is always tied to the rotor 802, so in the first mode the mass of rotor 802 is added to portion 807. In the second mode portion 808 (and hence the rotor) may rotate freely counterclockwise relative to portion 807, but not relatively clockwise.

Consider now that a user places the switch in the first mode position. In this state interface 809 constrains portion 807 by a ratchet mechanism (freewheel) to rotate clockwise relative to portion 805, but not counterclockwise. In the first mode also, portion 808 and 807 are locked together with the mass of the rotor added to portion 807. In this first mode, as a user alternatively applies the back-and-forth motion described above with reference to FIG. 7b or FIG. 6, the mechanism will wind the spring up to the point that the spring is fully wound. As the spring is winding the user will be able to feel the operation of the ratchet mechanism at interface 809, which will cease at the point that the spring is fully wound.

With the spring fully wound the user may operate the switch to place the mechanism in the second mode, wherein interface 809 is released, and interface 810 is constrained to allow portion 808 (hence the rotor) to rotate freely counterclockwise relative to portion 807, but not relatively clockwise. The result, with the user firmly grasping the casing, will be that the rotor will be spun by the spring within the stator. At the point that the spring is unwound, the rotor may continue to spin for a time until the magnetic forces decelerate it to stop. This operation will be useful for a user to store kinetic energy in the spring mechanism at any time, and then carry the apparatus for any time until electricity is needed, at which time the switch may operated to put the apparatus in the second, electricity-generating mode.

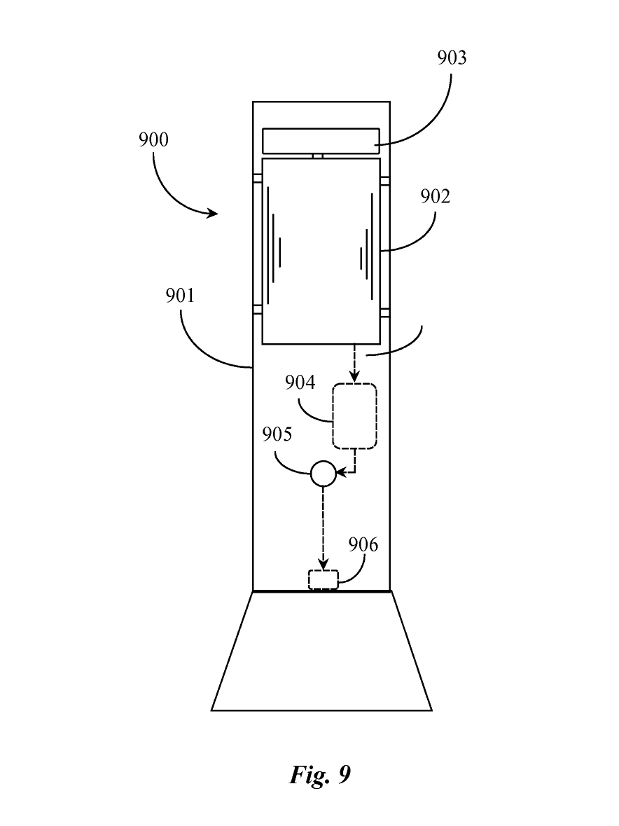

FIG. 9 illustrates yet another embodiment of the invention. In FIG. 9 a generating device has a casing 901 enclosing a commercially-available electric generating apparatus, such as a dynamo or an electric motor 902. Electric motors normally operate by providing electrical power to a provided input, and produce torque at an output shaft. If mechanical energy is provided to turn the output shaft (as an input), then the motor operates as a generator, and will produce an output voltage and current at the input leads.

In the embodiment depicted in FIG. 9 a flywheel 903 is added to the motor shaft to provide additional mass, and hence additional rotational inertia in operation, to the rotor assembly of motor 902. There may additionally be circuitry 904 to accept the electrical output from the motor (generator) in operation, to condition and alter the output, and to store electrical energy for use. Storage may comprise batteries of various sorts as well as capacitors and other circuitry. Further, although FIG. 9 illustrates a flashlight, the same or similar construction and functionality may be used for other devices and for a unit to be used simply for creating and storing electrical energy for a variety of uses.

Returning to FIG. 9, added flywheel 903 provides for rotational inertia such that when a user applies reciprocating action as per FIG. 6, for example, the motion turning the casing will provide relative motion between the motor rotor and stator. In an alternative embodiment flywheel 903 may be integrated with a freewheel mechanism constraining the flywheel, hence the motor shaft and rotor, to rotate only in one direction relative to the frame, hence the stator of the motor. Further still, mechanisms as described with regard to FIGS. 7 and 8 may be incorporated as well, and in some embodiments an off-center flywheel may be used for reasons alluded to above.

It will be apparent to one with skill in the art of electric generators that the rotor/stator assembly of the invention may be scaled up or extended linearly such as more than one assembly mounted linearly in a longer flashlight or other device. It will also be apparent to one with skill in the art that the rotor/stator assembly may be extended concentrically outward by adding rotational and fixed components, alternately, a rotor then stator then rotor, etc. to an extent practical considering diameter of the housing.

It will be apparent to one with skill in the art that the electric generating system of the invention may be provided using some or all of the mentioned features and components without departing from the spirit and scope of the present invention, and that lighting devices like flashlights are simply exemplary, and not limiting. Other embodiments may be conceived with respect to the device in which such a rotor/stator assembly might be used. For example, on a nano-scale, device sound waves or vibrations might be used as the manual input driver of the assembly. In one aspect or implementation water waves might be used to drive the assembly with the motions followed by floats and communicated to the device by suitable levers or mechanical components. In one implementation a generator in an embodiment described may be provided independently as a generating apparatus which may be connected to a separate energy storage like a battery pack. In one embodiment the generating device and a battery pack may be implemented as a unit, and may be connected as desired to any device needing electrical power, such as a laptop computer, cellular telephone, or any other electrical device.

It will also be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. An apparatus comprising:
a housing having a long axis;
a rotor mounted within the housing rotatable on one or more bearings on the same axis as the housing;
a stator concentric with the rotor, the stator constrained to be stationary relative to the housing; and
an arrangement of magnets and electrical windings configured to generate electrical current by relative rotation between the rotor and the stator;
wherein a user, grasping the housing, rotates the housing first in one rotational direction around the axis, and then in the opposite rotational direction around the axis, causing relative rotation between the stator and the rotor in repeating opposite directions, creating electrical current from the motion imparted.

2. The apparatus of claim 1 wherein the housing is adapted to be held between a users left and right hands, and the user imparts the repeated opposite rotational relative motion between the stator and the rotor by moving the opposite hands in opposite directions repeatedly.

3. The apparatus of claim 1 further comprising an electrical storage apparatus connected to the electricity generator with suitable circuitry such that electricity generated by relative rotation in either direction is stored in the storage apparatus.

4. The apparatus of claim 3 further comprising lighting components, wherein the apparatus provides a flashlight rechargeable by opposite rotation of the flashlight housing.

5. The apparatus of claim 1 further comprising a freewheel mechanism connected to the rotor, constraining the rotor to rotate in one direction only relative to the stator.

6. The apparatus of claim 1 comprising a plurality of rotors concentric with a plurality of stators with the stators all constrained to be stationary with the housing.

7. The apparatus of claim 6 wherein all of the rotors rotate independently.

8. The apparatus of claim 6 wherein individual ones of the rotors are constrained to rotate together.

9. The apparatus of claim 1 comprising a floating ring coupled to the stator by a spring element, with the floating ring coupled to the rotor by the freewheel mechanism, such that rotational input to the casing in the free direction of the rotor is imparted to the floating ring through the spring element, which directly drives the rotor through the freewheel mechanism, wherein upon the rotational input to the casing stopping, the rotor continues to rotate relative to the stator.

10. The apparatus of claim 1 comprising a mechanical connection to a wave follower, such that the wave follower causes the housing to rotate repeatedly in opposite directions, causing the apparatus to generate electrical current.

11. The apparatus of claim 1 further comprising a switch input controlling a mechanism between the stator and the rotor, wherein placing the switch in one position places the mechanism in a first mode enabling motion imparted to the casing to wind up a coil spring, and placing the switch in a second position places the mechanism in a second mode enabling the spring to unwind, spinning the rotor relative to the stator and generating electricity.

12. A method comprising:
rotating a housing as a first action in one rotational direction, causing relative rotation between a rotor mounted on bearings to rotate within the housing about the long axis of the housing, and a stator concentric with the rotor but fixed to be stationary relative to the housing, the apparatus having an arrangement of magnets and electrical windings configured to generate electrical current by relative rotation between the rotor and the stator;
rotating the housing as a second action in the opposite rotational direction generating further electrical current; and
repeating the steps sequentially to continue to produce electrical current.

13. The method of claim 12 wherein the housing is adapted to be held between a users left and right hands, and the user imparts the repeated opposite rotational relative motion between the stator and the rotor by moving the opposite hands in opposite directions repeatedly.

14. The method of claim 12 further comprising an electrical storage apparatus connected to the electricity generator with suitable circuitry such that electricity generated by relative rotation in either direction is stored in the electrical storage apparatus.

15. The method of claim 14 further comprising lighting components, wherein the apparatus provides a flashlight rechargeable by opposite rotation of the flashlight housing.

16. The method of claim 12 further comprising a freewheel mechanism connected to the rotor, constraining the rotor to rotate in one direction only relative to the stator.

17. The method of claim 12 comprising a plurality of rotors concentric with a plurality of stators with the stators all constrained to be stationary with the housing.

18. The method of claim 17 wherein all of the rotors rotate independently.

19. The method of claim 6 wherein individual ones of the rotors are constrained to rotate together.

20. The method of claim 12 comprising a floating ring coupled to the stator by a spring element, with the floating ring coupled to the rotor by the freewheel mechanism, such that rotational input to the casing in the free direction of the rotor is imparted to the floating ring through the spring element, which directly drives the rotor through the freewheel mechanism, wherein upon the rotational input to the casing stopping, the rotor continues to rotate relative to the stator.

21. The method of claim 12 comprising a mechanical connection to a wave follower, such that the wave follower causes the housing to rotate repeatedly in opposite directions, causing the apparatus to generate electrical current.

22. The method of claim 12 further comprising a switch input controlling a mechanism between the stator and the rotor, wherein placing the switch in one position places the mechanism in a first mode enabling motion imparted to the casing to wind up a coil spring, and placing the switch in a second position places the mechanism in a second mode enabling the spring to unwind, spinning the rotor relative to the stator and generating electricity.
